(19) United States
(12) Patent Application Publication
(10) Pub. No.: US 2002/0085597 A1
(43) Pub. Date: Jul. 4, 2002

(54) Laser diode module

(75) Inventor: Isamu Ohishi, Yokohama-shi (JP)

Correspondence Address: GREENBLUM & BERNSTEIN, P.L.C., 1941 ROLAND CLARKE PLACE, RESTON, VA, 20191, US

(73) Assignee: MORITEX CORPORATION

(21) Appl. No.: 10/011,727

(22) Filed: Dec. 11, 2001

(30) Foreign Application Priority Data
Dec. 12, 2000 (JP) 2000-377679

(51) Int. Cl. H01S 3/04; H01S 3/08

(52) U.S. Cl. 372/36; 372/108

(57) ABSTRACT

A laser diode module in which an optical system that magnifies NFP of the laser diode by twice or more and ten times or less is disposed along an optical axis z of a laser light from a laser diode, an elliptic core GI type optical fiber of a predetermined length and an elliptic core cross section with the major radius direction and the minor radius direction being aligned with the direction x and the direction y of the NFP respectively is disposed at an image formation position of the optical system, and a single mode optical fiber connected is connected to a light emitting end of the elliptic core GI type optical fiber, the diode module providing an advantage that the design and manufacture for the optical system are simple, production cost is reduced and a laser light even at a high aspect ratio can be introduced into a single mode optical fiber at a high coupling efficiency of 60% or more.

### BACKGROUND OF THE INVENTION

1. Field of the Invention

This invention concerns a laser diode module for outputting a laser light emitted from a laser diode by way of a single mode optical fiber disposed coaxially with an optical axis of the laser light.

2. Related Art Statement

Laser diodes have been used generally as a light source for use in optical communication or optical sensors. In most cases, since the laser light is transmitted in optical fibers, coupling of the laser diode and the optical fiber is extremely important for the constitution of an optical communication system or an optical sensing system.

However, since a laser diode has a considerably large beam emitting angle of 30 to 60° in a longitudinal direction and 10 to 30° in a lateral direction due to the refractive diverging, and has a characteristic that an optical spot diverges in an elliptic shape, it is difficult to restrict the elliptic light and introduce the same into circular core of a single mode optical fiber.

Particularly, a laser light at a wavelength of 980 nm which is used as an exciting light for an optical fiber amplifier which is important in view of optical communication forms a flattened elliptic optical spot with an aspect ratio (ellipticity=major radius/minor radius) of 3 or more, so that it is difficult to couple the optical spot to a single mode optical fiber of a circular core, and the transmission efficiency is lowered extremely in a case where the coupling between the laser diode and the optical fiber is poor.

In view of the above, for introducing a light with a high aspect ratio emitted from a laser diode into an optical fiber at an efficiency as high as possible, it has been attempted to use a condensing lens or an optical fiber lens modified at the top end shape of the optical fiber.

FIG. 6 shows a coupling system between a laser diode and an optical fiber known in the prior art. FIG. 6(a) shows an optical fiber lens coupling system in which a top end of a single mode optical fiber 42 opposing to a light emitting face 41a of a laser diode 41 is fabricated into a wedge-like tapered face 43 or a tapered surface of elliptic cone. FIG. 6(b) shows a single lens coupling system of locating a cylindrical lens 44 near a light emitting face 41a of a laser diode 41 to convert an emitted light into a circular light and then enter the same into an optical fiber 42.

According to the systems described above, coupling can be obtained with relatively low loss by setting a distance from the light emitting face of the laser diode to the optical fiber to 5-10 μm in the optical fiber lens coupling system shown in FIG. 6(a), or by setting a distance to the cylindrical lens 44 to about 10 μm in the single lens coupling system shown in FIG. 6(b).

However, since most of commercially available laser devices are adapted to tightly seal a laser diode in a can type housing in order to stabilize the output of the laser light and the surface of a sealing glass portion of the housing is situated at a distance of about 1 mm from the light emitting face of the laser diode, the optical fiber lens coupling system shown in FIG. 6(a) or the single lens coupling system shown in FIG. 6(b) involved a problem that such systems can not be adopted actually.

In view of the above, as a system of introducing a laser light emitted from a canned type laser device at a relatively high efficiency into a single mode optical fiber, it has also been proposed, a confocal composite lens coupling system of converting a laser light through a spherical lens 45 into a parallel light, condensing the parallel light by a rod lens 46 and then introducing the same into an optical fiber 42 as shown in FIG. 6(c), or a system of converting an elliptic light into a circular light by using a hybrid cylindrical lens 47 having two crossed axes and then introducing the same into an optical fiber 42 as shown in FIG. 6(d).

However, as shown in FIG. 7, in a confocal composite lens coupling system, a usual axis-symmetrical lens can not introduce a light with an accept ratio of 3 or more into an optical fiber at a coupling loss of 2.2 dB or less (with coupling efficiency of 60% or more).

Further, in the system of using the hybrid cylindrical lens 47 having two crossed axes, design and manufacture of the lens are difficult to increase the cost and, although the coupling efficiency is higher compared with other systems when coupling is conducted under an optimal condition, it is still difficult to obtain a coupling efficiency of 60% or more.

### OBJECT OF THE INVENTION

In view of the above, this invention intends to solve a technical subject of designing and manufacturing an optical fiber coupling system simply and at a reduced cost, and capable of introducing laser light with a high aspect ratio emitted in a diverged elliptic form from a laser diode tightly sealed in a housing into a single mode optical fiber of a circular core at a high coupling efficiency of 60% or more.

### SUMMARY OF THE INVENTION

For attaining the foregoing subject, this invention provides

a laser diode module of outputting a laser light having an elliptic optical spot shape emitted from a laser diode by way of a single mode optical fiber having a circular core, the laser diode module comprising;

a laser diode that emits a laser light having an optical axis z and forming an NFP (near field pattern) image with a major radius direction being defined as a direction x and a minor radius direction being defined as a direction y,

an optical system that is disposed along the optical axis z of the laser light from a laser diode and magnifies the NFP image of the laser diode by twice or more and ten times or less,

an elliptic core GI (Graded Index) type optical fiber of an elliptic core cross section that is disposed at an image formation position of the optical system, with the major radius direction and the minor radius direction being aligned with the direction x and the direction y of the NFP image respectively, and

a single mode optical fiber that is connected to a light emitting end of the elliptic core GI type optical fiber,

the elliptic core GI type optical fiber having such a length that, when a single mode light of a circular optical spot shape at a wavelength identical with that of the laser light is entered from one end thereof, the fiber emits from the other end of the fiber a light having an elliptic optical spot shape with a radius in the direction x and a radius in the direction y being substantially equal with the major radius and the minor radius of the NFP image respectively.

According to this invention, in a case where NFP as a laser light pattern just after emitted from the laser diode (near field pattern) is in the form of a laterally long elliptic pattern with an aspect ratio of 3.5, it is transmitted through a magnifying optical system such as an axis symmetrical convex lens and forms an image while being magnified by twice to 10 times at the incident end face of the elliptic core GI type optical fiber.

In this case, when the magnifying ratio is twice or more, since the incident angle to the elliptic core GI type optical fiber is 11° or less both in the longitudinal direction and in the lateral direction, this is less than the critical incident angle determined by the number of aperture of the optical quartz fiber of: NA=0.2.

Accordingly, most of laser light emitted from the laser diode is entered to the elliptic core GI type optical fiber.

In the elliptic core GI type optical fiber, since a core cross section is formed as an elliptic shape, the change of the period and the change of the amplitude of the optical spot radius of a light that propagates through the core are different with respect to the direction x and the direction y as the major radius and the minor radius direction, that is, both of the changes are larger in the direction x than in the direction y. When a single mode light of a circular optical spot shape at an wavelength identical with that of the laser light is entered from one end of the fiber, an optical spot light of an elliptic of circular optical spot shape is emitted from the other end thereof depending on the fiber length.

Accordingly, by properly selecting the length of the elliptic core GI type optical fiber, the elliptic optical spot shape of the light emitted from the other end of the fiber upon incidence of a single mode light can be made substantially equal with the NFP image regarding the major radius and the shorter radius.

When a real image of NFP is entered by using the elliptic core GI type optical fiber of such a determined length, since light travels reversibly and the light of an elliptic optical spot shape is converted into a single mode of a circular optical spot shape, it can be introduced at a high coupling efficiency into a single mode optical fiber.

### DESCRIPTION OF THE ACCOMPANYING DRAWINGS

FIG. 1 is a basic constitutional view of a laser diode module of this invention;

FIG. 2 is a cross sectional view of the laser diode module;

FIG. 3 is a cross sectional view of an elliptic core GI fiber;

FIG. 4 shows distribution of a refractive index of an elliptic core GI fiber;

FIG. 5 is a graph showing the change of the optical spot radius of light propagating in an elliptic core GI fiber;

FIGS. 6(a)-6(d) are explanatory views illustrating various coupling systems of laser diode modules in the prior art; and

FIG. 7 is a graph showing a relationship between an aspect ratio and a coupling loss.

### DESCRIPTION OF PREFERRED EMBODIMENTS

This invention is to be explained by way of a preferred embodiment with reference to the drawings.

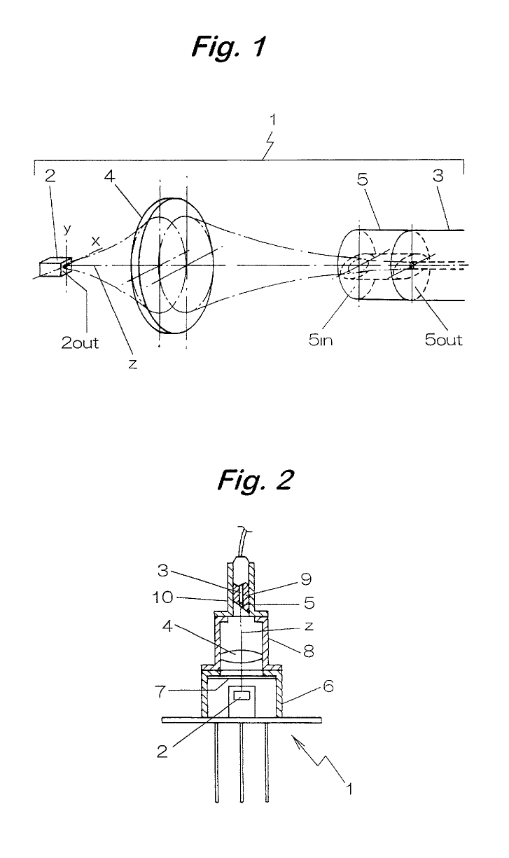

A laser diode module 1 shown in FIG. 1 and FIG. 2 is adapted to output a laser light emitted from a laser diode 2 by way of a single mode optical fiber 3 disposed coaxially with an optical axis z thereof.

Assuming the major radial direction and the minor radial direction of NFP, which is an optical spot pattern of a laser on a light emission face 2ₒᵤₜ of the laser diode 2 as the direction x and the direction y, an axis-symmetrical convex range (optical system) 4 for magnifying the NFP by twice or more and ten times or less is disposed along the optical axis z of a laser light. An elliptic core GI type optical fiber 5 having an elliptic core cross section with the major radial direction and the minor radial direction of the core being aligned with the direction x and the direction y respectively of NFP is located at an image formation position of the light. A single mode optical fiber 3 is connected to a light emitting end 5ₒᵤₜ of the fiber 5.

The laser diode 2 is tightly sealed in a can type housing 6 and the laser light is adapted to be emitted to the outside through a sealing glass portion 7.

A cylindrical lens holder 8 containing an axis-symmetrical convex lens disposed to the inside is YAG-welded to the housing 6. Further, a single mode optical fiber 3 having an elliptic core GI type optical fiber 5 fused at the top end is inserted being aligned through a ferrule 9, and a sleeve 10 in which the ferrule 9 is inserted and secured is YAG-welded to the lens holder 8.

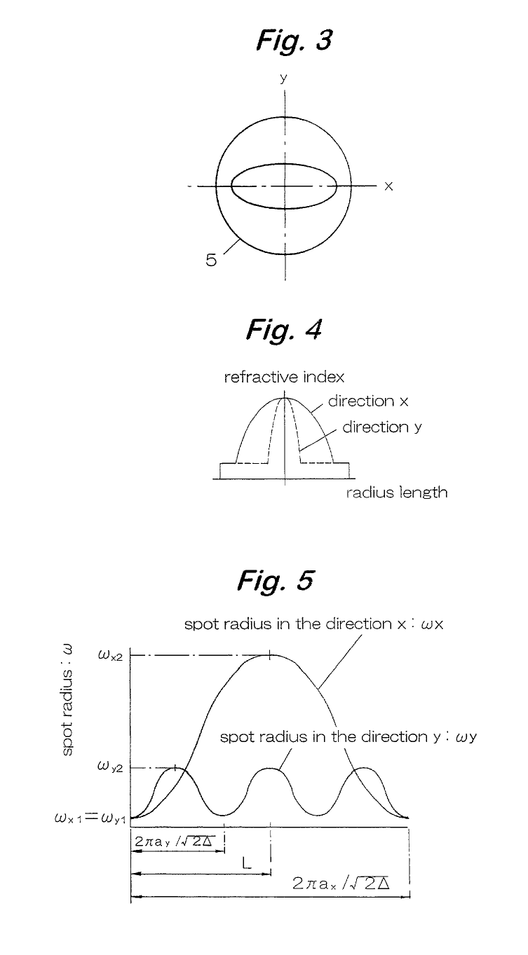

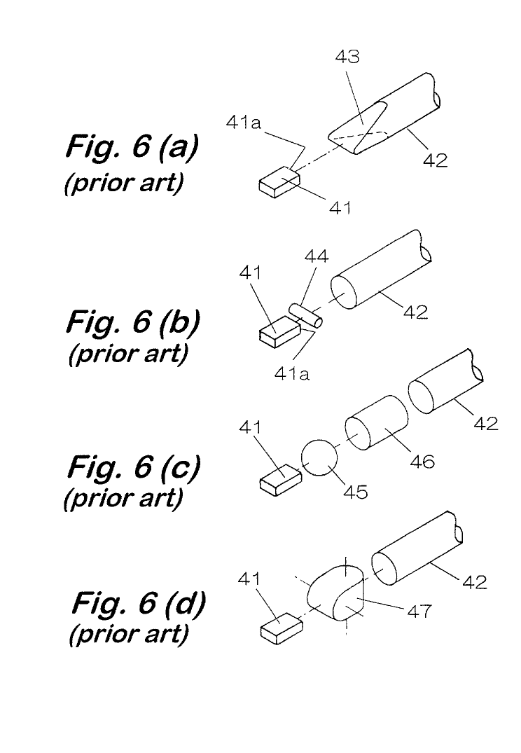

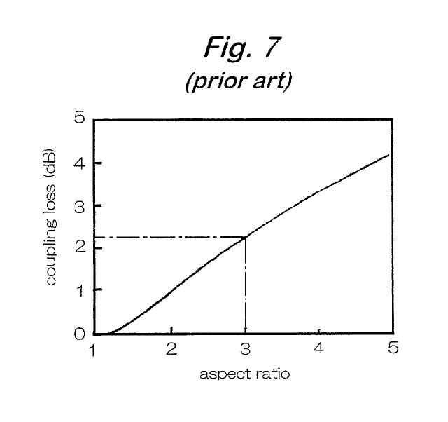

The elliptic core GI type optical fiber 5 is formed into a laterally long ellipsis similar with NFP such that the elliptic ratio at the core cross section is substantially equal with the aspect ratio of NFP as shown in FIG. 3.

Further, a graded index optical fibers (GI type optical fiber) having a parabolic distribution shape both in the direction x and direction y with the gradient for the distribution of the refractive index being different with each other is used as shown in FIG. 4.

Generally, a single mode light that propagates through an optical fiber periodically changes its optical spot radius in accordance with the propagation distance. In the single mode light propagating through the elliptic core GI type optical fiber 5, the change in period and the change in the amplitude of the optical spot radius is different between the direction x and direction y in which both of changes are greater in the direction x than in the direction y.

Then, when a single mode light at a wavelength identical with that of the laser light is entered from one end of this optical fiber, a light of an elliptic or circular optical spot shape determined depending on the length of the elliptic core GI type optical fiber 5 is emitted from the other end as shown in FIG. 5.

Accordingly, by properly selecting the length of the elliptic core GI type optical fiber, when a single mode light is entered, the elliptic optical spot shape of a light emitted from the other end can be made substantially equal with the NFP image, regarding the minor radius and the major radius.

Since the light propagates reversibly, when an NFP image is focused at the light incident end 5ᵢₙ of the elliptic core GI type optical fiber 5, it is outputted from an light emitting end 5ₒᵤₜ as a single mode light of a circular optical spot shape, which is then introduced into the single mode optical fiber 3.

An example for the constitution of the laser diode module 1 according to this invention is as has been described above and the operation thereof is to be explained below.

Explanation is to be made for a case of introducing a laser light emitted from the laser diode 2 at a wavelength of 980 nm, with an aspect ratio of 3.5 and with a radius in the direction x: ωₓ₀=2.43 μm and a radius direction y: ω_{y0}=0.7 μm in NFP into a single mode optical fiber 3 having a core radius of 6.2 μm.

In this specification, the extent of the optical spot means that within a range having a light intensity of 1/e² for the light intensity at the center.

Assuming the magnifying ratio of the axis-symmetrical convex lens 4 as: m=10, the distance from the light emitting face 2a of the laser diode 2 to the axis-symmetrical convex lens 4 as d₀ and the distance from the axis-symmetrical convex lens 4 to the image formation position as d₁, the following equation is established.

d₁=md₀

Since d₁=20 mm when the d₀=2 mm, the core GI type optical fiber 5 is disposed at a position where the distance from the axis-symmetrical convex lens 4 to the light incident 5ᵢₙ is 20 mm.

Since the magnifying ratio is 10, the size of the NFP real image at the image formation position is such that the radius in the direction x: ωₓ=24.3 μm and radius in the direction y: ω_{y}=7.0 μm.

On the other hand, when a single mode light at a wavelength λis entered to the elliptic core GI type optical fiber 5, the radius in the direction x: ωₓ and the radius in the direction y: ω_{y} change along with propagation in the core as shown in FIG. 5.

Assuming the change of period in the direction x as Cx, and the max value and the Min value for radii of the spots as ωₓ₁ and ωₓ₂, the following equations are established:

Cx=2π*aₓ/√(2Δ)

ωₓ₁*ωₓ₂=(λ/n₁π)*aₓ/√(2Δ)

where

Δ=(n₁−n)/n₂

aₓ:core radius

n₁:refractive index at the center core

n₂:refractive index at the clad

λ:wavelength

The same equations as direction x are established about values of direction y.

In this embodiment, when the single mode light at a wavelength of 980 nm, with a spot radius ωₓ₁=ω_{y1}=3.10 μm is entered into the elliptic core GI type optical fiber 5 having Δ=1.0%, and an elliptic spot with radius in the direction x:ωₓ₂=24.3 μm and radius in the direction y:ω_{y2}=7.0 μis intended to the outputted, the core radius aₓ and a_{y} and the core length L can be determined based on the above equations as:

aₓ=49.6 μm

a_{y}=14.3 μm

L=550.9 μm

Accordingly, when an elliptic core GI type optical fiber 5 having a core with the radius in the direction x of 99.2 μm, the radius in the direction y of 28.6 μm and a length of 550.9 μm is fused to the top end of a single mode optical fiber 3 and a laser light of an NFP real image is entered to the light incident end 5ᵢₙ of the elliptic core GI type optical fiber 5, the light propagates reversibly and a single mode light at a 980 nm is emitted from the light emitting end of the fiber 5 and then introduced into a single mode fiber 3 of 6.2 μm core radius.

In case where the laser light emitted from the laser diode 2 diverges at a radiation angle of 30°, the radius in the direction y is about 2.3 mm at the position for the lens 4. Since the image formation position is spaced apart by 20 mm from the lens 4, the angle of condensed light is about 6.5°, which is smaller than the critical incident angle of 11° determined by the number of aperture NA of 0.2 of the quartz fiber.

Further, since the radiation angle in the direction x is smaller than that in the direction y, the angle of condensed light is naturally 6.5° or less which is also smaller than the critical incident angle of 11°.

Therefore, most of the light after transmitting the lens is incident to the elliptic core GI type optical fiber 5 with scarce coupling loss.

As described above, an overall coupling efficiency as high as 80% can be obtained that exceeds the theoretical limit of 60% in a case of using the axis symmetrical lens system.

When the outer profile of the elliptic core GI type optical fiber 5 is made identical with the outer profile of the single mode optical fiber 3, they can be fused more easily to each other.

In this case, when the magnification ratio of the axis-symmetrical convex lens 4 is made greater than ten times, the distance from the axis-symmetrical convex lens 4 to the light incident end 5ᵢₙ of the elliptic core GI type optical fiber 5 exceeds 20 mm in practical use and the module is enlarged in the size and increased in the cost. In addition, an allowable angle of inclination of the elliptic core GI type optical fiber 5 is narrowed as ±0.3° within a range of the coupling loss of 1 dB, which worsens the yield upon assembling the laser module.

On the other hand, in a case of using an axis-symmetrical convex lens 4 having a magnifying ratio of less than twice and having a radius capable of receiving 90% of the laser light emitted from the laser diode, since the angle of condensed light is enlarged, it may sometimes cause a trouble that light can not be taken into the elliptic core GI type optical fiber 5 having NA=0.2.

In addition, an allowable tolerance for the positional displacement in the orthogonal direction of the elliptic core GI type optical fiber 5 is narrowed as ±0.7 μm within the coupling loss of 1 dB, which worsens the yield upon assembling.

Accordingly, the magnifying ratio of the lens is limited within 2 to 10 times and, preferably, 3 to 5 times.

In the foregoings, although explanations have been made to a case where the axis-symmetrical convex lens 4 is disposed to the outside of the housing 6, it may be disposed within the housing 6.

Further, although the axis-symmetrical convex lens 4 is explained as a separate member, it may be integrally formed with the sealing glass portion 7 of the housing 6.

Furthermore, enlarging optical system is not limited to a single lens system of the axis-symmetrical convex lens 4 but plural lens may be used in combination.

As has been described above, this invention can provide an excellent effect, capable of converting most of laser light irradiated in an elliptic optical spot shape into a circular spot shape and introducing the same at an extremely high coupling efficiency into the single mode optical fiber even in a case where the lens is inevitably spaced from the laser diode as in a laser diode tightly sealed in a housing.

Further, since a lens, a single mode optical fiber having an elliptic core GI type optical fiber coupled at the top end may be fixed successively to the outside of the housing relative to the laser diode sealed within the housing, it can also provide an advantage that the design is easy and labors of manufacture can be moderated, to decrease the manufacturing cost.

The present disclosure relates to subject matter contained in priority Japanese Patent Application No. 2000-377,679 filed on Dec. 12, 2000, the contents of which is herein expressly incorporated by reference in its entirety.

What is claimed is:

1. A laser diode module of outputting a laser light having an elliptic optical spot shape emitted from a laser diode by way of a single mode optical fiber having a circular core, the laser diode module comprising;
a laser diode that emits a laser light having an optical axis z and forming an NFP (near field pattern) image with a major radius direction being defined as a direction x and a minor radius direction being defined as a direction y,
an optical system that is disposed along the optical axis z of the laser light from a laser diode and magnifies the NFP image of the laser diode by twice or more and ten times or less,
an elliptic core GI (Graded Index) type optical fiber of an elliptic core cross section that is disposed at an image formation position of the optical system, with the major radius direction and the minor radius direction being aligned with the direction x and the direction y of the NFP image respectively, and
a single mode optical fiber that is connected to a light emitting end of the elliptic core GI type optical fiber,
the elliptic core GI type optical fiber having such a length that, when a single mode light of a circular optical spot shape at a wavelength identical with that of the laser light is entered from one end thereof, the fiber emits from the other end of the fiber a light having an elliptic optical spot shape with a radius in the direction x and a radius in the direction y being substantially equal with the major radius and the minor radius of the NFP image respectively.

2. A laser diode module according to claim 1, wherein the laser diode is tightly sealed in a housing, and a laser light of the diode transmits a sealing glass portion and enters to the elliptic core GI type optical fiber.

3. A laser diode module according to claim 1, wherein a cylindrical lens holder containing an axis-symmetrical convex lens in the inside is attached to the housing, and a sleeve in which the single mode optical fiber connected at the top end thereof with the elliptic core GI type optical fiber is aligned and secured is attached to the lens holder.

4. A laser diode module according to claim 1, wherein the axis-symmetrical convex lens is disposed in the housing or formed integrally with the sealing glass portion of the housing.
